(19) United States
(12) Patent Application Publication
(10) Pub. No.: US 2023/0365854 A1
(43) Pub. Date: Nov. 16, 2023

(54) COPOLYMER ADDITIVES FOR CRUDE OIL, MIXTURES OF SAID ADDITIVES AND CRUDE OIL, AND METHODS FOR PRODUCING AND USING SAID MIXTURES

(71) Applicant: Cameron International Corporation, Houston, TX (US)

(72) Inventors: Christopher S. Daeffler, Sugar Land, TX (US); Graham Robert Drummond, Aberdeen (GB); Grady F. Parker III, Houston, TX (US); Hema Rampersad, Katy, TX (US)

(21) Appl. No.: 17/663,576

(22) Filed: May 16, 2022

(51) Int. Cl. C09K 8/524

(52) U.S. Cl. CPC C09K 8/524

(57) ABSTRACT

Copolymer additives for crude oils, crude oil mixtures of the copolymer additives and crude oils, and methods for producing or forming the crude oil mixtures are provided. The crude oil mixtures and methods comprise at least copolymer additive introduce or applied to crude oil, wherein the at least one copolymer additive comprises one or more copolymers of vinylpyrrolidone and one or more alpha-olefins.

### FIELD OF THE DISCLOSURE

The present disclosure is generally directed to copolymer additives for crude oils, crude oil mixtures of the copolymer additives and crude oils, methods for producing, forming, or providing the crude oil mixtures, and methods for using, deploying, and circulating the crude oil mixtures. The copolymer additives are added to, mixed with, or applied to the crude oils to produce, form, or provide the crude oil mixtures. The methods for producing and/or using the crude oil mixtures may comprise applying the copolymer additives to the crude oils and/or circulating the copolymer additives into either a subterranean flow path comprising at least one crude oil, at a surface facility, and/or at a subsea facility. The copolymer additives may comprise one or more copolymers of vinylpyrrolidone and one or more alpha-olefins.

### BACKGROUND

Wax crystal formation in crude oils is common during well operation, as the crude oils cool from bottomhole static temperatures to mudline or surface conditions. Overtime, the wax crystals can coat the interior of wellbore equipment, leading to higher pressure drops and lower production rates. Often, the wax crystal formation leads to gelation and formation of gelled oils. The high viscosities of the gelled oils create challenges during the storage and transport of crude oil produced from a well or wellbore, as heating would be required to achieve enough flowability to move the crude oil between containers.

Traditionally, at least one paraffin inhibitor (hereinafter “PI”) additive and/or at least one pour point depressant (hereinafter “PPD”) additive is applied to or introduced into a crude oil during production to affect, slow and/or reduce wax crystal formation, deposition and gelling in the crude oil. During production, the PI additive is often introduced to the crude oil to slow a rate of wax deposition in the crude oil and/or the PPD additive is introduced to the crude oil so that the crude oil is flowable at anticipated surface conditions which may include, for example, seabed, subterranean pipelines, or a combination thereof. The PI and/or the PPD additive(s) may sometimes be applied to the crude oil downhole to reduce the rate of wax deposition in the crude oil and/or improve flowability of the crude oil, respectively. Molecular structures of the PI and/or the PPD additive(s) is/are typically designed to co-crystallize or adsorb to wax during crystallization and alter the wax crystal morphology so wax crystals do not adhere to metal surfaces, such as, for example, metal casing or tubing surfaces and/or a weaker gel network may be formed, respectively. However, each crude oil is a unique, complex mixture of components that can be saturated or unsaturated, polar or non-polar, and/or charged or neutral. Often, the PI additive also functions as a weak PPD additive as a side effect which may further improve flowability of the crude oil at the anticipated surface conditions.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one or more embodiments, a crude oil mixture may comprise crude oil and at least one copolymer additive comprising at least one copolymer of vinylpyrrolidone and at least one alpha-olefin.

In an embodiment, the at least one copolymer of vinylpyrrolidone and at least one alpha-olefin may be according to the general structure (I)

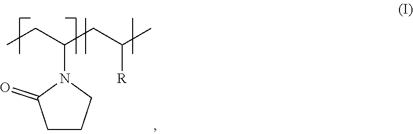

wherein R may be an alkyl group comprising at least about 12 carbon atoms and no more than about 36 carbon atoms.

In an embodiment, the alkyl group may comprise at least about 14 carbon atoms and no more than about 28 carbon atoms.

In an embodiment, the at least one copolymer additive may be a copolymer additive solution comprising the at least one copolymer of vinylpyrrolidone and at least one alpha-olefin dissolved or suspended in a solvent of the copolymer additive solution.

In an embodiment, the solvent of the copolymer additive solution may be at least one hydrocarbon solvent, at least one organic solvent, at least one aromatic solvent, or a mixture thereof.

In an embodiment, the copolymer additive solution may be present in the crude oil mixture at a concentration ranging from about 100 ppm to about 10,000 ppm.

In an embodiment, the concentration of the copolymer additive solution present in the crude oil mixture may be at least about 1,000 ppm.

In an embodiment, the at least one alpha-olefin of the at least one copolymer may comprise a blend of alpha-olefins having different side chain lengths.

In an embodiment, the at least one copolymer additive further may comprise at least one selected from poly(ethylene-co-vinyl acetate), one or more graft polymers of poly(ethylene-co-vinyl acetate), functionalized poly(olefin-co-maleic anhydride), poly(alkylacrylate), functionalized poly(styrene-co-maleic anhydride), poly(alkylmethacrylates), one or more alkyl fumarate copolymers, one or more methacrylic/acrylic copolymers, one or more vinyl acetate olefin copolymers, one or more alkyl phenol resin copolymers, one or more hyperbranched or dendrimeric copolymers, and a mixture thereof.

In one or more embodiments, a crude oil mixture may comprise crude oil and a copolymer additive solution that may comprise at least one copolymer dissolved or suspended within a solvent of the copolymer additive solution, wherein the at least one copolymer may be according to the above-identified general structure (I), wherein R may be an alkyl group.

In an embodiment, the alkyl group may comprise at least about 12 carbon atoms and no more than about 36 carbon atoms.

In an embodiment, the copolymer additive solution may be present in the crude oil mixture at a concentration ranging from about 50 ppm to about 100 ppm, from no more than about 150 ppm, or from about 750 ppm to about 3,500 ppm.

In an embodiment, the concentration of the copolymer additive solution present in the crude oil mixture may range from about 1,000 ppm to about 2,000 ppm.

In an embodiment, the alkyl group may comprise at least about 14 carbon atoms and no more than about 28 carbon atoms.

In one or more embodiments, a method may comprise applying at least one copolymer additive to a crude oil, wherein the at least one copolymer additive may comprise one or more copolymers of vinylpyrrolidone and one or more alpha-olefins.

In an embodiment, the one or more copolymers of the method may be according to the above-identified general structure (I), wherein R may be an alkyl group comprising at least 12 carbon atoms and no more than 36 carbon atoms.

In an embodiment, the one or more copolymers of the method may be dissolved or suspended in a solvent to produce the at least one copolymer additive.

In an embodiment, the method may further comprise flowing the crude oil in a subterranean flow path from a reservoir to a surface while the at least one copolymer additive is applied to the crude oil.

In an embodiment, the method may further comprise receiving the crude oil at a facility or providing the crude oil to the facility and applying the at least one copolymer additive to the crude oil, wherein the facility my be selected from the group consisting of a surface facility, a subsea facility, and a combination thereof.

In an embodiment, the method may further comprise introducing the at least one copolymer additive into a wellbore comprising the crude oil to apply the at least one copolymer additive to the crude oil.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

The present disclosure is, generally, directed to one or more PI additives and/or one or more PPD additives (collectively referred to hereinafter as “the present additive” or “the present additives”) for one or more crude oils (hereinafter “the crude oil” or “the crude oils”). The present additives may be added to, applied to, and/or mixed with the crude oils to provide, produce, and/or form one or more crude oil mixtures (hereinafter “the crude oil mixture” or “the crude oil mixtures”). After introduction or application to the crude oils, the present additive affects, reduces, or prevents wax crystal formation in the crude oils. The present additives may be added, applied, and/or introduced to the crude oils during production to slow, reduce, or prevent a rate of wax deposition in the crude oils. Additionally, the present additives may be added, applied, and/or introduced to the crude oils during production so that the crude oils are flowable or have improved flowability at anticipated surface conditions. Alternatively, the present additives may be added, applied, and/or introduced to the crude oils at or during other operations besides production. Moreover, the present additives may have at least one molecular structure that co-crystallizes and/or adsorbs to wax during crystallization and alters the crystal morphology so the crystals fail to adhere to one or more metal surfaces. Furthermore, one or more weaker gel networks may be formed based on or as a result of molecular structures of the present additives.

In one or more embodiments, the present additive may be or may comprise one or more copolymer additives (hereinafter “the copolymer additive” or “the copolymer additives”) that are based on or derived from at least one vinylpyrrolidone (hereinafter “VP”) and one or more alpha-olefins having one or more side chains. The one or more side chains of the one or more alpha-olefins may have same or similar chain lengths, substantially same or similar chain lengths, one or more different chain lengths, one or more substantially different chain lengths, or a combination thereof. In some embodiments, the one or more copolymer additives may have the following general structure (I):

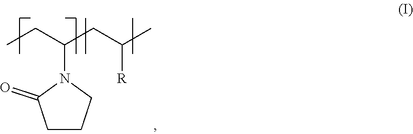

wherein the copolymer additive is or comprises at least one VP/alpha-olefin copolymer and R is or comprises at least one alkyl group having a number of carbon atoms.

In some embodiments, the general structure (I) of the VP/alpha-olefin copolymer additives may have one or more variations. In an embodiment, a first variation may be monomer contents of the copolymer additives and a second variation may be polymerization mechanisms of the copolymer additives. In some embodiments, the alpha-olefin monomers of the copolymer additives may have one or more different side chain lengths, or may be a blend of monomers having one or more different side chain lengths. Further, the copolymer additives disclosed herein may comprise one or more other polymerizable olefins. For example, other polymerizable olefins, such as, styrene may be incorporated into and/or included in the copolymer additives disclosed herein. In one or more embodiments, the polymerization mechanisms of the copolymer additives disclosed herein may comprise or may be either a one-step copolymerization process or a two-step copolymerization process. For example, all monomers may be mixed together via the one-step copolymerization process or VP may first be polymerized and then may act as an initiator for the alpha-olefins via the two-step copolymerization process.

In one or more embodiments, the number carbon atoms of the one or more alkyl groups of the copolymer additives may range from about 12 carbon atoms to about 36 carbon atoms, from about 12 carbon atoms to about 30 carbon atoms, from about 14 carbon atoms to about 30 carbon atoms, from about 14 carbon atoms to about 28 carbon atoms, from about 30 carbon atoms to about 36 carbon atoms, or a combination thereof. The chain lengths of the alpha-olefin monomers and/or the alkyl groups may be sufficiently long such that the alpha-olefin monomers and/or the alkyl groups may provide one or more waxy side chains of the copolymer additives that may be capable of incorporation into at least one growing wax crystal. If the pyrrolidone moiety of the copolymer additive is displayed or disposed on the surface of the wax crystal, then the pyrrolidone moiety may change, adjust, or alter one or more characteristics and/or structural features of the at least one growing wax crystal. For example, the pyrrolidone moiety may change the growing wax crystal from a nonpolar molecule or crystal to polar molecule or crystal. The change, adjustment, or alteration from nonpolar to polar may make subsequent crystal-crystal interactions unfavorable and/or may reduce the chance of the wax crystal(s) subsequently being deposited or disposed onto the one or more metal surfaces, such as, for example, one or more metal casing surfaces, one or more metal tubing surfaces, other metal surfaces, or a combination thereof.

The copolymer additives disclosed herein may be a liquid copolymer additive or a solid copolymer additive. Thus, the copolymer additives disclosed herein may be in either liquid form or solid form. In an embodiment, the copolymer additives may be a mixture of one or more liquids and one or more solids. In one or more embodiments, the copolymer additives may be clear and/or colorless or may comprise a color, such as, for example, white powder or solid particles.

The one or more different chain lengths of the alpha-olefin monomers or the alkyl groups of the copolymer additives may have total chain lengths ranging from about C8 to about C36, from about C10 to about C36, from about C12 to about C30, or from about C12 to about C28. In some embodiments, the side chains of the copolymer additives may be or may be based on at least one alkane, at least one alkene, and/or at least one aliphatic hydrocarbon which may be branched or unbranched. In an embodiment, the side chains of the copolymer additives may be based on and/or derived from at least one of hexadecene, eicosane, triacontane, and a combination thereof.

In one or more embodiments, the copolymer additives disclosed herein may be mixed, added, incorporated, or introduced into the crude oil to form, produce, or provide the crude oil mixture. The concentration or dosage of the copolymer additive in the crude oil mixture may be at least about 10 parts per million (hereinafter “ppm”), at least about 50 ppm, at least about 100 ppm, at least about 500 ppm, at least about 750 ppm, at least about 1000 ppm, at least about 1250 ppm, at least about 1500 ppm, at least about 1750 ppm, at least about 2000 ppm, at least about 2500 ppm, or at least about 3000 ppm. In some embodiments, the concentration or dosage of the copolymer additive in the crude oil mixture may be no more than about 5000 ppm, no more than about 4000 ppm, no more than about 3000 ppm, no more than about 2500 ppm, no more than about 2000 ppm, no more than about 1500 ppm, no more than about 1250 ppm, no more than about 1000 ppm, no more than about 750 ppm, no more than about 150 ppm, or no more than about 100 ppm. In some embodiments, the concentration or dosage measurements or ranges in ppm may be with respect to copolymer additives themselves or with respect to the copolymer additives that are dissolved or suspended in at least one solvent.

In some embodiments, the copolymer additives disclosed herein may be a blended additive comprising the copolymers of VP and one or more alpha-olefins blended with other PI additives, other PPD additives, other crude oil additives, or a combination thereof. For example, the present copolymer additives may be at least one blended additive comprising the VP/alpha-olefin copolymers formulated with at least one selected from poly(ethylene-co-vinyl acetate) (hereinafter “EVA”), one or more graft polymers of EVA, functionalized poly(olefin-co-maleic anhydride), poly(alkylacrylate), functionalized poly(styrene-co-maleic anhydride), poly(alkylmethacrylates), one or more alkyl fumarate copolymers, one or more methacrylic/acrylic copolymers, one or more vinyl acetate olefin copolymers, one or more alkyl phenol resin copolymers, one or more hyperbranched or dendrimeric copolymers, and/or a mixture thereof. Maleic anhydride in the polymers, when present, may be further derivatized by at least one reaction with alcohol(s) to form esters or alkylamines to form maleimide. Moreover, the copolymer additives disclosed herein may be formulated with one or more wax dispersants selected from, for example, dodecylbenzenesulfonic acid salts, ethoxylated alcohols, or a mixture thereof.

In some embodiments, the copolymer additives disclosed herein may be in the form of a solution, such as, for example, a VP/alpha-olefin copolymer additive solution. The VP/alpha-olefin copolymer additive solution may comprise at least one VP/alpha-olefin copolymer dissolved or suspended in at least one solvent of the copolymer additive solution. The at least one solvent of the copolymer additive solution may be at least one selected from, for example, at least one organic solvent, at least one hydrocarbon solvent, at least one aromatic solvent, or a mixture thereof. In some embodiments, the at least one organic solvent may be an aqueous-based solution, the at least one hydrocarbon solvent may be benzene, toluene, xylene, acetone, methanol, or a mixture thereof, and the at least one aromatic solvent may be at least one C9, C10, and C11 aromatic fluid and/or may have an aromatic content of about 97%, about 98%, or about 99% or higher. The at least one aromatic solvent may be, for example, naphthalene-depleted, ultra-low naphthalene, or a mixture thereof. In an embodiment, water may be utilized and/or may carry solid polymers as a dispersion or slurry and/or liquid polymers as an emulsion.

In embodiments, the copolymer additive disclosed herein may be added to, mixed with, and/or applied to at least one crude oil, which may also be referred to hereinafter as petroleum or oils, to produce, provide, and/or form one or more crude oil mixtures. The at least one crude oil may comprise unrefined petroleum and/or liquid petroleum comprising naturally occurring hydrocarbons and/or organic compounds. The hydrocarbons may comprise methane, ethane, propane, butane, pentane, other heavy hydrocarbons, or a mixture thereof. The hydrocarbons may be one or more selected from alkanes or paraffins, cycloalkanes or naphthenes, aromatic hydrocarbons, asphaltics, or a mixture thereof. The at least one crude oil may also comprise other organic compounds, such as, for example, nitrogen, oxygen, sulfur, metals, or a mixture thereof. The metals may be, for example, iron, nickel, copper, vanadium, or a mixture thereof. In embodiments, the at least one crude oil may comprise carbon, hydrogen, nitrogen, oxygen, sulfur, metals, or a mixture thereof. One or more natural gases may be dissolved within the at least one crude oil. In some embodiment, the at least one crude oil may comprise resins, alkanes or paraffins, cycloalkanes or naphthenes, naphthenic acid, aromatic hydrocarbons, asphaltenes, or a mixture thereof.

Crude oil may be recovered or recoverable by oil drilling in a geological formation beneath the Earth's surface. The crude oil and/or other produced fluids may flow from a reservoir of the geological formation into a wellbore or borehole (hereinafter “the wellbore”) drilled, formed, or disposed within the geological formation. It should be understood that the present disclosure is not limited to specific embodiments with respect to drilling techniques and/or drilling operations for drilling, forming, or disposing the wellbore within the geological formation. The wellbore may be drilled into or formed within the geological formation by one or more drilling techniques and/or drilling operations as known to one of ordinary skill in the art.

In some embodiments, the present copolymer additive may be added to, mixed with, and/or applied to at least one wellbore fluid. The wellbore fluid may comprise water and/or brines containing various electrolytes and their blends. In some embodiments, the wellbore fluid may further comprise at least one selected from NaCl, KCl, CaCl2), NaBr, CaBr2, ZnBr2, and a combination thereof. In other embodiments, the wellbore fluid may be a non-aqueous fluid, an oil-based fluid, a synthetic-based fluid, or a mixture thereof. In some embodiments, the wellbore fluid may comprise at least one additive material that may affect or change one or more characteristics and/or properties of the wellbore fluid, wellbore, the crude oil, or a combination thereof. In an embodiment, the at least one additive material of the wellbore fluid may perform one or more wellbore functions within the wellbore. For example, the at least one additive material may be a weighting agent, viscosifier, lubricant, a combination thereof, or the like. It should be understood that the present disclosure is not limited to specific embodiments of the wellbore fluid and/or the at least one additive material of the wellbore fluid. The wellbore fluid and/or the additive material may be any wellbore fluid and/or any additive material as known to one of ordinary skill in the art.

In embodiments, the present methods disclosed herein may treat the at least one crude oil with the present copolymer additive to improve, change, or modify one more characteristics and/or properties of the crude oil. For example, the present copolymer additive may be injected into or emplaced within the wellbore to prevent, reduce, or minimize paraffin deposition therein and/or may be introduced into the at least one crude oil. In an embodiment, the present copolymer additive may be added to crude oil before the crude oil cools to its cloud point. In another embodiment, the present copolymer additive may function as a paraffin dispersant when added to crude oil after the crude oil has cooled below its cloud point. Additionally, the present copolymer additive may be added to, applied to, and/or mixed with at least one crude oil as a pour point depressant. As a result of the application of the present copolymer additive to the crude oil, the pour point temperature of the crude oil may decrease or be depressed from a first temperature to a second temperature.

In some embodiments, the present methods disclosed herein may comprise adding, applying, and/or introducing the present copolymer additive to crude oil. The present copolymer additive may be directly added or applied to crude oil or may be in the form of the VP/alpha-olefin copolymer additive solution that is added or applied to the crude oil. The present copolymer additive or copolymer additive solution may be added to, applied to, or mixed with the crude oil to produce, provide, or form the crude oil mixture wherein the present copolymer additive or copolymer solution is present at a concentration with respect to the overall crude oil mixture. The concentration or dosage of the present copolymer additive or copolymer additive solution in the crude oil mixture may be no more than about 150 ppm, from about 50 ppm to about 10,000 ppm, from about 250 ppm to about 7,500 ppm, from about 500 ppm to about 5,000 ppm, from about 750 ppm to about 3,500 ppm, from about 1,000 ppm to about 2,000 ppm, or from about 50 ppm to about 100 ppm. In an embodiment, the concentration or dosage of the present copolymer additive or copolymer additive solution may be an effective amount that decreases wax or paraffin deposition within the crude oil mixture, decreases or depresses the pour point temperature of the crude oil to the second temperature, and/or reduces or lowers the viscosity of the crude oil for improving the flow characteristics of the crude oil.

In some embodiments, the present method disclosed herein may comprise flowing the crude oil in a subterranean flow path from the reservoir to the surface and/or dissolving and/or suspending the copolymer additive in a solvent to produce, provide, or form the present copolymer additive or the present copolymer additive solution. Further, the present method may comprise adding or applying the present copolymer additive to the crude oil or to the subterranean flow path comprising the crude oil for producing, providing, or forming the crude oil mixture. Still further, the present method may comprise receiving the crude oil at a facility or providing the crude oil to the facility and applying the present copolymer additive or copolymer additive solution to the crude oil, wherein the facility may be disposed at the surface and/or at a subsea surface. Moreover, the present method may comprise adding the present copolymer additive to a wellbore fluid and/or introducing the wellbore fluid comprising the present copolymer additive or copolymer additive solution into a wellbore formed in a geological formation. Alternatively, the present method may comprise emplacing the present copolymer additive and/or the copolymer additive solution into the wellbore during at least one well operation, wherein the wellbore comprises the crude oil.

### EXAMPLES

Three VP/alpha-olefin copolymer additives having side chain compositions and physical forms are disclosed below in Table 1.

TABLE 1
VP/alpha-olefin copolymer additive properties.

| Additive | Side chains | Physical form |
|---|---|---|
| Copolymer 1 | C14 (from hexadecene) | clear liquid |
| Copolymer 2 | C18 (from eicosene) | white solid |
| Copolymer 3 | C28 (from triacontene) | white solid |

In some embodiments, Copolymer 1 and Copolymer 2 may be copolymers of VP and hexadecene and eicosene, respectively, and Copolymer 3 may comprise a polyvinylpyrrolidone core that may act as or be an initiator to triacontene oligomerization.

### Example 1

To apply the three copolymer additives disclosed herein to crude oils and to aid dispersion, each of the copolymer additives (i.e., Copolymers 1-3) was dissolved or suspended in xylene at an active concentration of about 20% by weight.

Paraffin deposition was evaluated in a lab setting with the cold finger experiment. In some examples, the crude oil was held at or above its wax appearance temperature (hereinafter “WAT”) in a heating bath. In other examples, the cold finger experiment are performed below the WAT. A metal cylinder was suspended in the heated oil and then itself cooled to a temperature that is intended to replicate operating conditions. The crude oil was stirred at different rates to mimic the shear of crude oil passing through tubulars of a well. At the end of the experiment(s), the cold finger was removed from the crude oil and the wax deposit was weighed. The efficacy of each paraffin inhibitor (i.e., Copolymers 1-3) was measured as the percentage difference between the treated and uninhibited blank sample:

Inhibition (%)=100*(Mb−Mt)/Mb,

wherein Mb=mass of the wax deposit from an uninhibited crude oil blank, and Mt=mass of the wax deposit from a crude oil treated with a paraffin inhibitor.

Copolymers 1-3 were tested against two crude oil samples. A first crude oil sample (hereinafter “Crude Oil A”) had a WAT of about 17° C. The cold finger experiment was conducted at an oil temperature of about 30° C., a finger temperature of about 2° C., and a stir bar speed of about 300 RPM. The experiment duration was 18 hours. The experiments were conducted in three sets, with five blanks and six treated samples. The VP/alpha-olefin additive solutions (i.e., Copolymers 1-3) were added to the treated samples at concentrations of about 1000 ppm and about 2000 ppm.

To calculate the inhibition of the VP/alpha-olefin copolymers (i.e., Copolymers 1-3), blank runs were averaged (experiments 2.1 through 2.5; average=0.71 g). The three VP/alpha-olefin additives (i.e., Copolymers 1-3) showed an amount of inhibition (see Table 2). Copolymer 3, with longer side chains than the side chains of Copolymers 1 and 2, showed substantial improved effectiveness with respect to Crude Oil A; however, both Copolymers 1 and 2 also showed to be substantially effective inhibitors with respect to Crude Oil A.

TABLE 2
Cold finger experiments with Crude Oil A

| Exp. | | Doseage | Wax Deposit | |
|---|---|---|---|---|
| # | Inhibitor | (ppm) | (g) | Inhibition |
| 1 | Blank | 0 | 0.55 | |
| 2 | Blank | 0 | 0.64 | |
| 3 | Blank | 0 | 0.83 | |
| 4 | Blank | 0 | 0.80 | |
| 5 | Blank | 0 | 0.73 | |
| 6 | Copolymer 1 | 1000 | 0.63 | 11% |
| 7 | Copolymer 2 | 1000 | 0.63 | 11% |
| 8 | Copolymer 3 | 1000 | 0.60 | 15% |
| 9 | Copolymer 1 | 2000 | 0.57 | 20% |
| 10 | Copolymer 2 | 2000 | 0.76 | −7% |
| 11 | Copolymer 3 | 2000 | 0.52 | 27% |

### Example 2

The second crude oil sample tested (hereinafter “Crude Oil B”) with the VP/alpha-olefin copolymers had a WAT of about 50.6° C. and a wax disappearance temperature of about 59.1° C. The Crude Oil was heated to about 46.1° C. for the cold finger experiments. The cold fingers were maintained at about 36.1° C. The stir bar was spun at about 350 RPM. For Crude Oil B, all inhibitors (i.e., Copolymers 1-3) were dosed at about 1000 ppm. Due to known variability at high deposition temperatures, six blank samples were used, each from a different finger on the apparatus. The average blank deposition was 79.0 mg.

The inhibition of the treated samples was compared to the average of all blanks, and compared to the finger on which it was run (see Table 3).

TABLE 3
Cold finger experiments with Crude Oil B

| | | | Wax | | |
|---|---|---|---|---|---|
| Exp. | Cold | | Deposit | Inhibition | Inhibition |
| # | Finger | Inhibitor | (mg) | by finger | by average |
| 1 | 1 | Blank | 67.4 | | |
| 2 | 2 | Blank | 80.8 | | |
| 3 | 3 | Blank | 103 | | |
| 4 | 4 | Blank | 74.2 | | |
| 5 | 5 | Blank | 72.3 | | |
| 6 | 6 | Blank | 76.4 | | |
| 7 | 6 | Copolymer 1 | 50.0 | 35% | 37% |
| 8 | 3 | Copolymer 2 | 99.8 | 3% | −26% |
| 9 | 2 | Copolymer 3 | 12.3 | 85% | 84% |

The deposit for Copolymer 2 is the greatest of all measurements with respect to Crude Oil B or, in other words, there was increased wax deposition for Copolymer 2 at the concentration of about 1000 ppm in Crude Oil B. Copolymers 1 and 3 both decrease the wax deposit on the cold finger with respect to Crude Oil B. The inhibition provided by Copolymer 3, about ˜84%, is or may be substantially practical for one or more field applications.

### Example 3

To apply the above-identified three copolymer additives to crude oil samples and to aid dispersion, each copolymer additive (i.e., Copolymers 1-3) were dissolved in xylene at an active concentration of about 20% by weight. Each of the three crude oil samples (i.e., Crude Oils B, C, and D) were treated with the copolymer solutions and the pour point for each crude oil sample was analyzed using adaptations of the ASTM D5853 method. The Crude Oils B, C, and D was examined with the ASTM D5853 minimum pour point method as follows:
1. Crude Oils B, C, and D were each heated to about 60° C. for about 30 minutes in a water bath.
2. Each of the Crude Oils B, C, and D was dosed with about 1500 ppm, about 1000 ppm, and 1000 ppm, respectively, of the copolymer solutions, shaken, then returned to about 60° C. water bath for 30 minutes.
3. The samples were removed, transferred to pour point tubes, and capped with a stopper equipped with a centralized thermometer.
4. Starting at about 36° C. as the samples cooled, and about every 3° C. after that, the samples were gently tilted. If crude oil interface was immobile after 5 seconds with the tube held parallel to the ground, the sample was considered to be below its pour point. The last observation in which the interface moved (i.e., about 3 degrees above the observation with the immobile interface) is pour point.
5. To maintain a constant cooling rate, the samples were transferred between a series of cooling baths as required:

If the internal temperature of the crude oil sample reached 30° C., the tube was moved to an about 0° C. bath;

If the internal temperature of the crude oil sample reached about 9° C., the tube was moved to an about −18° C. bath;

If the internal temperature of the crude oil sample reached about −9° C., the tube was moved to an about −33° C. bath;

If the internal temperature of the crude oil sample reached about −24° C., the tube was moved to an about −51° C. bath; and

If the crude oil sample reaches about −36° C., and the oil is still mobile, the experiment ends.

The results of the pour point experiments for Crude Oils B, C, and D are contained in Table 4. The blank pour points for Crude Oils B, C, and D were about −3° C., about 36° C. and 30° C., respectively. Copolymer 2 affected both Crudes B and D, and Copolymer 3 affected each of Crude Oils B, C, and D. Copolymer 1 had no effect on any of Crude Oil B, C, and D.

TABLE 4
Effect of copolymer solutions on pour
point with Crude Oils B, C, and D

| | Pour point, | Pour point, | Pour point, |
|---|---|---|---|
| Pour Point | Crude Oil B | Crude Oil C | Crude Oil D |
| Depressant | (° C.) | (° C.) | (° C.) |
| Blank | −3 | 36 | 30 |
| Copolymer 1 | −3 | 36 | 30 |
| Copolymer 2 | −24 | 36 | 27 |
| Copolymer 3 | −9 | 33 | 24 |
| Doseage (ppm) | 1500 | 1000 | 1000 |

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

1. A crude oil mixture comprising:
crude oil; and
at least one copolymer additive comprising at least one copolymer of vinylpyrrolidone and at least one alpha-olefin.

2. The crude oil of claim 1, wherein the at least one copolymer of vinylpyrrolidone and at least one alpha-olefin is according to the general structure; 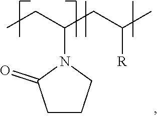
wherein R is an alkyl group comprising at least about 12 carbon atoms and no more than about 36 carbon atoms.

3. The crude oil mixture of claim 2, wherein the alkyl group comprises at least about 14 carbon atoms and no more than about 28 carbon atoms.

4. The crude oil mixture of claim 1, wherein the at least one copolymer additive is a copolymer additive solution comprising the at least one copolymer of vinylpyrrolidone and at least one alpha-olefin dissolved or suspended in a solvent of the copolymer additive solution.

5. The crude oil mixture of claim 4, the solvent of the copolymer additive solution is at least one hydrocarbon solvent, at least one organic solvent, at least one aromatic solvent, or a mixture thereof.

6. The crude oil mixture of claim 4, wherein the copolymer additive solution is present in the crude oil mixture at a concentration ranging from about 100 ppm to about 10,000 ppm.

7. The crude oil mixture of claim 4, wherein the concentration of the copolymer additive solution present in the crude oil mixture is at least about 1,000 ppm.

8. The crude oil mixture of claim 1, wherein the at least one alpha-olefin of the at least one copolymer comprises a blend of alpha-olefins having different side chain lengths.

9. The crude oil mixture of claim 1, wherein the at least one copolymer additive further comprises at least one selected from poly(ethylene-co-vinyl acetate), one or more graft polymers of poly(ethylene-co-vinyl acetate), functionalized poly(olefin-co-maleic anhydride), poly(alkylacrylate), functionalized poly(styrene-co-maleic anhydride), poly(alkylmethacrylates), one or more alkyl fumarate copolymers, one or more methacrylic/acrylic copolymers, one or more vinyl acetate olefin copolymers, one or more alkyl phenol resin copolymers, one or more hyperbranched or dendrimeric copolymers, and a mixture thereof.

10. A crude oil mixture comprising:
crude oil; and
a copolymer additive solution comprising at least one copolymer dissolved or suspended within a solvent of the copolymer additive solution, wherein the at least one copolymer is according to the general structure; 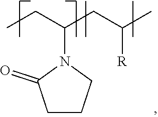
wherein R is an alkyl group.

11. The crude oil mixture of claim 10, wherein the alkyl group comprises at least about 12 carbon atoms and no more than about 36 carbon atoms.

12. The crude oil mixture of claim 11, wherein the copolymer additive solution is present in the crude oil mixture at a concentration ranging from about 750 ppm to about 3,500 ppm.

13. The crude oil mixture of claim 12, wherein the concentration of the copolymer additive solution present in the crude oil mixture ranges from about 1,000 ppm to about 2,000 ppm.

14. The crude oil mixture of claim 12, wherein the alkyl group comprises at least about 14 carbon atoms and no more than about 28 carbon atoms.

15. A method comprising:
applying at least one copolymer additive to a crude oil, wherein the at least one copolymer additive comprises one or more copolymers of vinylpyrrolidone and one or more alpha-olefins.

16. The method of claim 15, wherein the one or more copolymers of vinylpyrrolidone and one or more alpha-olefins are according to the general structure 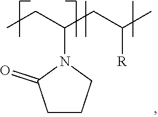
wherein R is an alkyl group comprising at least 12 carbon atoms and no more than 36 carbon atoms.

17. The method of claim 15, wherein the one or more copolymers of vinylpyrrolidone and one or more alpha-olefins are dissolved or suspended in a solvent to produce the at least one copolymer additive.

18. The method of claim 15, further comprising:
flowing the crude oil in a subterranean flow path from a reservoir to a surface while the at least one copolymer additive is applied to the crude oil.

19. The method of claim 15, further comprising:
receiving the crude oil at a facility or providing the crude oil to the facility; and
applying the at least one copolymer additive to the crude oil,
wherein the facility is selected from the group consisting of a surface facility, a subsea facility, and a combination thereof.

20. The method of claim 15, further comprising;
introducing the at least one copolymer additive into a wellbore comprising the crude oil to apply the at least one copolymer additive to the crude oil.

21. The crude oil mixture of claim 11, wherein the copolymer additive solution is present in the crude oil mixture at a concentration ranging from about 50 ppm to about 100 ppm, from no more than about 150 ppm.
